(19) United States
(12) Patent Application Publication
(10) Pub. No.: US 2012/0002029 A1
(43) Pub. Date: Jan. 5, 2012

(54) SYSTEM AND METHOD FOR SWEEPING MIRROR ENHANCED IMAGING FLOW CYTOMETRY

(75) Inventors: Christian K. Sieracki, Edgecomb, ME (US); Scott N. Ellis, Topsham, ME (US); Kent A. Peterson, Yarmouth, ME (US)

(73) Assignee: FLUID IMAGING TECHNOLOGIES, INC., Yarmouth, ME (US)

(21) Appl. No.: 12/826,850

(22) Filed: Jun. 30, 2010

(51) Int. Cl. H04N 7/18

(52) U.S. Cl. 348/79; 348/61; 348/E07.085

(57) ABSTRACT

An imaging flow cytometry system and method which includes a flow chamber, tracking mirror, microscope and imaging optics, image capturing system, device to regulate fluid flow through the chamber, and backlighting generator. The tracking mirror moves at a rate matched to the particle velocity in the flow chamber so as to enhance the sample flow rates possible with the system while maintaining clear and accurate imaging. The backlighting generator passes through the flow chamber and the objective before being focused on the image capturing system. Detected scatter events initiate tracking by the mirror, resulting in imaging with reduced motion blur even at high rates of flow.

### FIELD OF THE INVENTION

The present invention relates generally to an optical flow imaging and analysis configuration used in particle analysis instrumentation, and more particularly to an optical flow imaging system and method incorporating a flow chamber and a tracking mirror which sweeps at a rate which is matched to the fluid flow rate, enabling accurate imaging at flow rates much faster than previously enabled.

### BACKGROUND OF THE INVENTION

Various optical/flow systems employed for transporting a fluid within an analytical instrument to an imaging and optical analysis area exist in the art. A liquid sample is typically delivered into the bore of a flow chamber and the sample is interrogated in some way so as to generate analytical information concerning the nature or properties of the sample. For example, a laser beam may excite the sample present in the bore of the flow cell, and the emitted fluorescence energy provides signal information about the nature of the sample.

If the system incorporates particle imaging, the imaging is generally accomplished by generating an extremely short flash to image the passing particle with a CCD or CMOS camera. A flash on the order of 100 microseconds is used, and it is necessary to keep the flow of the sample to less than one-tenth of a milliliter per minute to prevent motion blurring in the resulting images.

The inefficiencies of standard methods of optically imaging with a very short flash, an objective lens and a CCD camera include using a very slow sample flow to prevent image blur, low image illumination energy from the sample, and accidental imaging of contamination on the walls of the flow cell. Therefore, there is a need in the art for an effective way to prevent image blur and allow longer exposures when imaging a rapidly-moving sample.

### SUMMARY OF THE INVENTION

It is an object of the present invention to provide an imaging flow cytometry system and method with improved sample fluid flow rate. It is also an object of the present invention to provide such an improved flow rate imaging flow cytometer system and method that may be incorporated into, or used with, existing imaging flow cytometers and provide better images with reduced blurring. These and other objects are achieved with the present invention, which enables imaging of higher than conventional sample flow rates through introduction of a tracking mirror, wherein the movement of the mirror is associated with the fluid flow rate. In other words, the tracking mirror is configured to track particles passing in the fluid at a known flow rate. In one embodiment, the imaging flow cytometry system and method of the present invention includes a scanning galvanometer mirror, a galvanometer driver circuit, one or more high current power supplies, a modification of an imaging flow cytometer's digital signal processor, and ramp generator electronic circuitry. The tracking minor allows the imaging system to track particles as they flow through the flow chamber, enabling clear imaging of the particles even when the sample is moving quickly. Specifically, when properly controlled, the tracking mirror reflects the magnified image of the particle obtained at particular moments by the backlighting generator to the same points on the face of the camera, correcting for motion associated with the sample flow. As such, the camera is able to image passing particles for a longer time without motion blur and obtain a clearer image of the particle than is otherwise possible. This configuration allows a dramatically improved sample flow rate suitable for analyzing large samples in a short span of time while obtaining clear and accurate images of particles in the sample. Use of the system and method of the present invention also prevent samples under examination from spoiling or deteriorating due to long processing times required when sample flow rates are low.

On the image capturing side, the present invention is an optical system and method including a light source and an image capturing system. In one embodiment, the present invention includes a backlighting generator, an image capturing system, a microscope objective, a rectangular flow chamber of known dimensions, a device which draws the sample through the flow chamber at a well regulated rate, an imaging objective, as well as an electronic ramp generator circuit, a galvanometer and mirror which can be controlled by the ramp generator, and a galvanometer driver circuit which can control the galvanometer with the ramp waveform. In this embodiment, high current power supplies are also needed for proper operation of the various elements. In a preferred embodiment, the image capturing system includes a camera. In a more preferred embodiment, the camera is a CCD or CMOS camera.

If the tracking mirror involves a galvanometer, the galvanometer and mirror are controlled by a ramp generator to allow the camera to track particles in the flow of sample as they are passing in front of the objective within the flow chamber by matching the sweep of the mirror to the well-controlled sample flow rate. The flashing imaging light source generates light which passes through the flow chamber and then the objective before being focused onto the imaging camera. If fluorescence emissions are monitored by the system, they are deflected by another mirror to appropriate detectors. This combination enables high clarity images in the flow cytometry imaging system and method of the present invention. Specifically, the present system and method allow higher sample flow and higher quality images than available with existing imaging cytometry. Further, the invention allows the use of longer exposure times for imaging, resulting in brighter, less noisy images. In addition, the invention prevents imaging flow cytometers from imaging blemishes on the flow chamber walls since they are smeared or blurred beyond recognition. In contrast, state of the art imaging flow cytometers image the flow cell channel with a flash and consequently, will image any particles or blemishes on the channel walls clearly in addition to imaging desired particles in the sample. In the present invention, moving the mirror during the flash results in a motion smeared image of these particles or blemishes and will blend them in with the background, making such particles easier to avoid with image capturing.

These and other advantages of the present invention will become more readily apparent upon review of the following detailed description, the accompanying drawings, and the appended claims.

### BRIEF DESCRIPTION OF THE DRAWINGS

FIG. 1 schematically illustrates one embodiment of the system of the present invention for imaging particles in a fluid.

FIG. 2 is a block diagram of the signal processor designed for use in one embodiment of the invention.

FIG. 3 illustrates the timing of the sweep and imaging signals in relation to the triggering light signal.

FIG. 4 illustrates the details of the sweep and imaging signals.

FIG. 5 illustrates a schematic of one embodiment of the programmable electronic ramp generator for use in one embodiment of the invention

FIG. 6 is a schematic representation of the relationship between a particle in the fluid flow, the objective, the tracking mirror and the imaging device.

FIG. 7 is a collection of images of marine plankton taken with a current state of the art imaging flow cytometer with a high speed sample flow rate.

FIG. 8 is a collection of images of marine plankton taken with a sweeping mirror enhanced imaging flow cytometry system of the present invention operating at a high speed sample flow rate.

FIG. 9 is another collection of images of marine plankton taken with a sweeping mirror enhanced imaging flow cytometry system of the present invention operating at a high speed sample flow rate.

FIG. 10 is a flow diagram representing steps to be carried out using the sweeping mirror enhanced imaging flow cytometry system of the method of the present invention.

### DETAILED DESCRIPTION OF THE PREFERRED EMBODIMENT

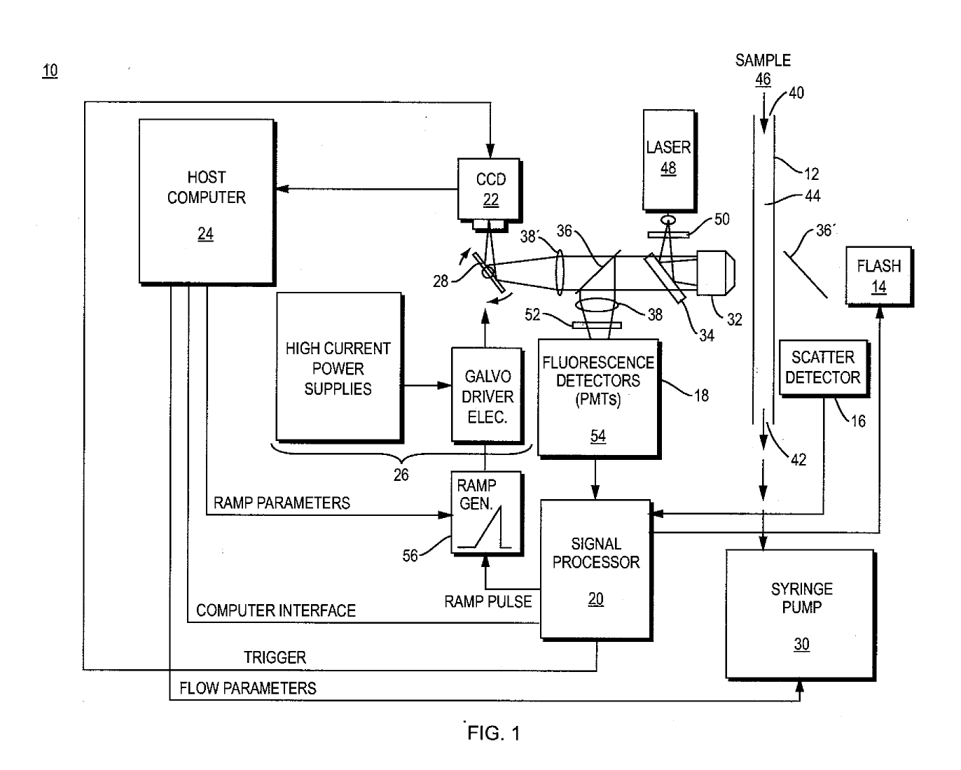

One embodiment of a system 10 of the present invention suitable for high speed automated counting and/or imaging of particles in a fluid is shown in FIG. 1. The system 10 includes a flow chamber 12, a backlighting generator 14, particle scatter and fluorescence detectors 16, 18, a signal processor 20, an image capturing system 22, a computing device 24, a scan generator circuit 26 including high current power supplies and galvanometer driver electronics to control programmable ramp generator 56, a scanning galvanometer and mirror combination 28, and a pump 30 capable of delivering a controllable fluid flow rate. The embodiment of the system 10 depicted in FIG. 1 also includes imaging and analysis optics such as the microscope objective 32, dichroic mirror 34, partial mirrors 36, 36′, and lenses 38 and 38′, although other configurations are possible. The combination of the components of the system 10 arranged and configured as described herein enable a user to detect and image particles without blurring in a fluid sample at flow rates not possible with existing imaging flow cytometers.

The flow chamber 12 includes an inlet 40 for receiving the particle containing fluid to be observed, and an outlet 42 through which the fluid passes out of the flow chamber 12 after imaging and particle optical measurement functions have been performed. The flow chamber 12 is a low fluorescence structure of known dimensions. That is, it must be fabricated of a material that does not readily fluoresce, for example, but not limited to, microscope glass or rectangular glass extrusions. The flow chamber 12 is of rectangular shape and defines a channel 44 through which the fluid flows at a predetermined controllable rate. In some embodiments, the channel 44 within the flow chamber 12 is of rectangular configuration with a known cross sectional depth (D) and width (W). An example of a suitable form of the flow chamber 12 is a W1050 Vitxotube from Vitrocom, Inc. (River Lakes, N.J., US). The inlet 40 of the flow chamber 12 is connectable to a fluid source such as sample 46 and the outlet 42 is connectable to a downstream device for transferring the fluid away from the flow chamber 12 at a well-controlled, steady and adjustable rate. A suitable example of such a fluid transfer device is the pump 30, which may be a model 210 programmable syringe pump from KD Scientific, Inc. (Holliston, Mass., US).

A light source 48 is used to generate fluorescence and scatter light directed to the flow chamber 12, resulting in particle fluorescence and/or light scatter. The light source 48 may be a laser with, an excitation filter 50. The light source 48 may be, but is not limited to, a 473 nanometer (nm), 488 nm or 532 nm solid state model laser available from an array of manufacturers known to those of skill in the art. The excitation filter 50 should at least have the characteristic of being able to transmit light at wavelengths longer than the wavelengths of light generated by the light source 48. An example of a suitable form of the excitation filter 50 is a 505DCLP longpass filter available from Chroma Technologies (Rockingham, Vt., US), which can be used with a 488 nm laser. Those of skill in the art will recognize that other suitable filters may be employed for the excitation filter 50.

Any particle fluorescence emissions from the flow chamber 12 that have a wavelength of 535 to 900 nm are detected by the detection system, which includes at least one or more emission filters 52 and one or more high sensitivity photomultiplier tubes (PMTs) 54 within the fluorescence detector 18. The emission filters 52 should at least have the characteristic of being transparent to the fluorescence emissions of a desired fluorophore. An example of a suitable form of an emission filter 52 is a 570/40 phycoerithryn emission filter available from Chroma Technologies (Rockingham, Vt., US); those of skill in the art will recognize that other suitable filters may be employed for the emission filter 52. The PMTs 54 should at least have the characteristic of being sensitive to the fluorescence emissions desired. An example of a suitable PMT is the H9656-20 model available from Hamamatsu (Bridgewater, N.J., US); those of skill in the art will recognize that other equivalent PMTs may be employed for the PMT 54.

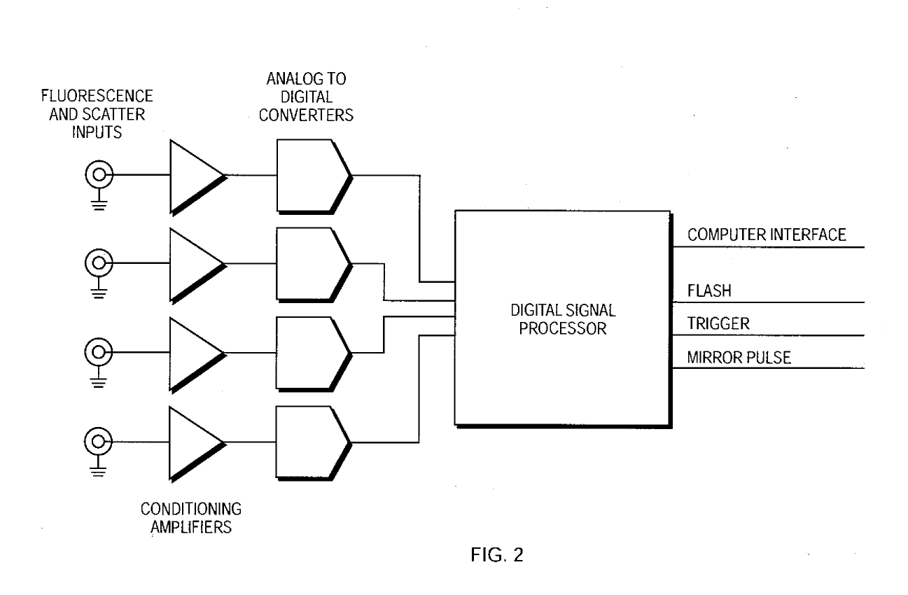

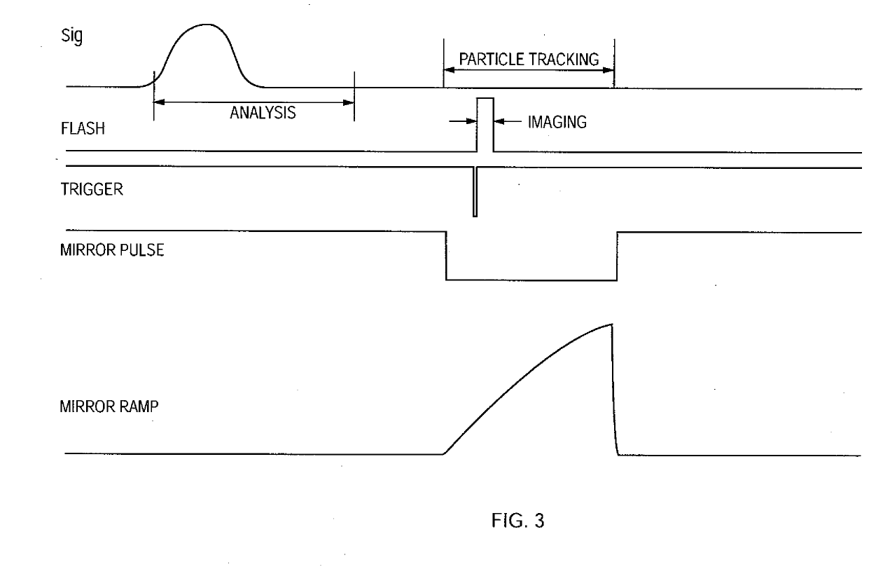

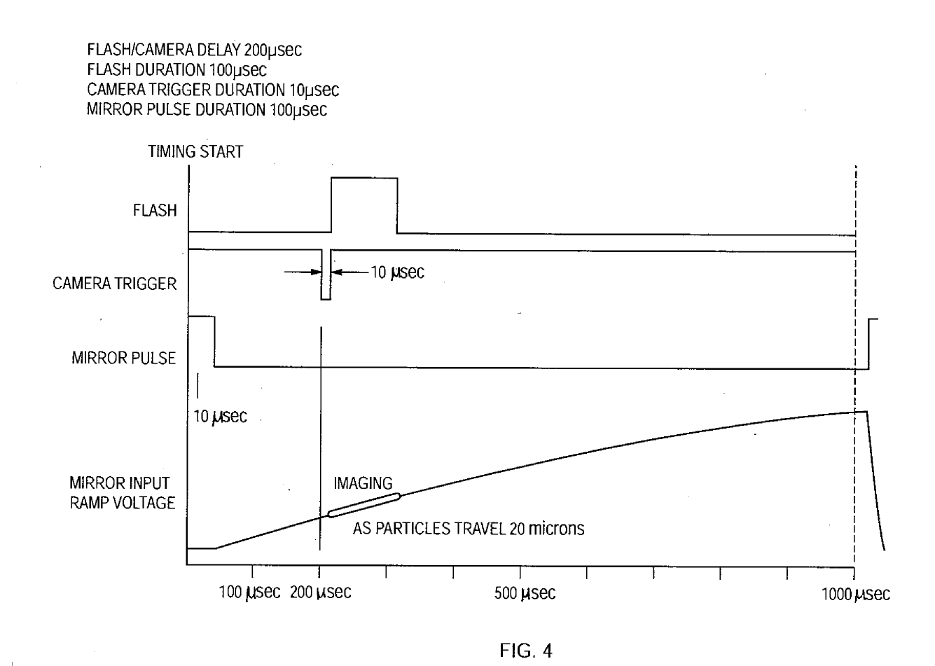

Preferably, the signal processor 20 includes a user adjusted threshold setting which determines the amount of fluorescence or scatter required for the system 10 to acknowledge a passing particle. For example, and in no means limiting the scope of the invention, the user may set the threshold to be 200 (dimensionless cytometer fluorescence or scatter units). One embodiment of a signal processor 20 that can be used in the system 10 or method of the present invention is shown in FIG. 2. Scatter and fluorescence inputs are processed by conditioning amplifiers where they may be amplified and/or converted to their logarithm for better dynamic range as is commonly done in flow cytometers. These signals are then converted to digital signals which are analyzed by the signal processor 20. Programming of the signal processor 20 determines how it analyzes and reacts to these inputs. In this invention, the signal processor 20 is programmed to monitor the scatter and fluorescence inputs and, if any of these inputs are greater than a predetermined threshold, initiate the signal sequence, also called the particle tracking interval, seen in FIGS. 3 and 4.

When an input is greater than a predetermined threshold, indicating presence of a particle to be imaged, for example, the signal processor 20 initiates a particle tracking interval, as shown in FIGS. 3 and 4. The first step of the particle tracking interval is initiation of a mirror pulse, which is converted to a mirror ramp signal by the programmable ramp generator 56. After initiation of the mirror pulse and ramp, a camera trigger and then a flash signal to the backlighting generator 14 are initiated. The exposure of the camera and resultant imaging overlap the period where the sample is illuminated by the flash. Representative samples of the time periods for each element of the particle tracking interval are shown in FIG. 4. Input from a scatter and/or fluorescence detector initiates the particle tracking interval, which starts with initiation of the mirror pulse after a brief delay. The mirror pulse is converted to the ramp signal, and the pulse and ramp may run for approximately 1000 μseconds. After approximately 200 μseconds the mirror is moving sufficiently to start tracking and imaging particles and a brief camera trigger signal is initiated. The trigger initiates a flash and the camera exposure, which is of controlled duration. In FIG. 4 the flash and associated imaging are shown as occurring over approximately 100 μseconds. The time periods described herein are examples only, and it is to be understood that other time periods or timing conditions may be established without deviating from the invention.

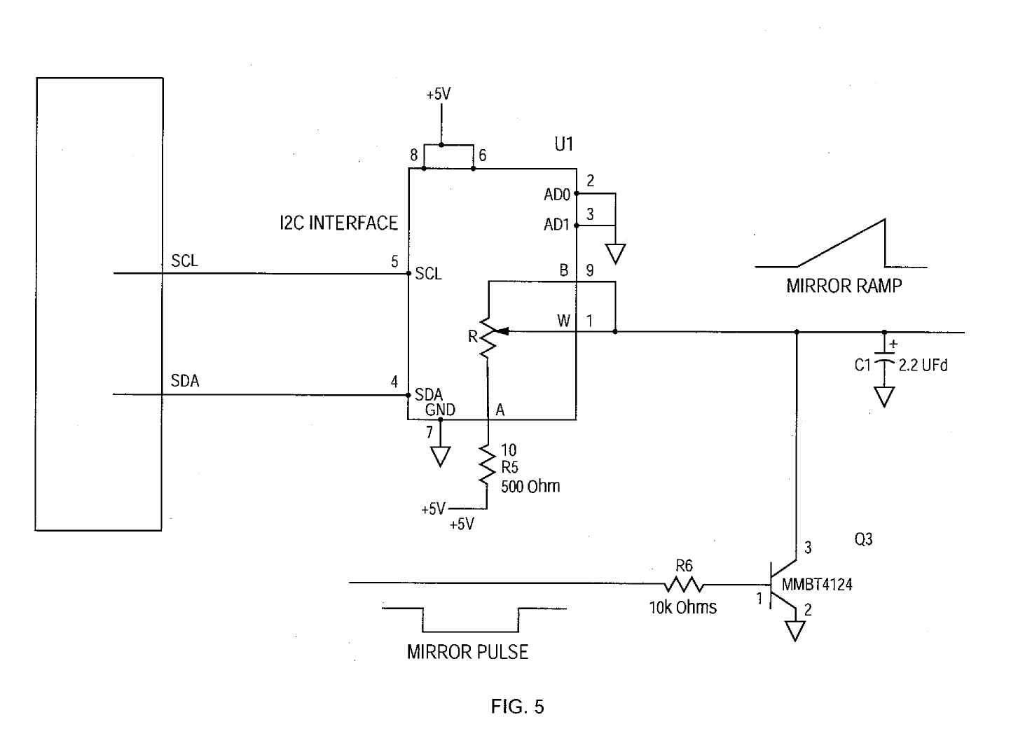

Programmable ramp generator 56 may be configured to sweep its output voltage at different rates, depending on its setting. The functions of the ramp generator 56 are achieved by the structure shown in the schematic of one specific embodiment shown in FIG. 5. The ramp generator 56 receives a ramp parameter control signal from the computing device 24 which sets the internal resistance R of the digital potentiometer U1. This resistance determines the rate at which the ramp voltage rises. Together, components R, R5 and C1 determine the change rate of this ramp voltage with time when transistor Q3 is turned off. The voltage change rate is determined from the charge rate of capacitor C1, which generates a voltage of 0.632 times the voltage +5V in a time of (R+R5)*C1 in this example. When the mirror pulse signal from the signal processor 20 makes a high to low transition, the bipolar transistor Q3 turns off and the capacitor C1 begins charging at this charge rate.

It is to be understood that FIG. 5 depicts only one type of ramp generator 56 suitable for use in the present invention. Those skilled in the art can readily envisage alternative computer interfaces that could be used with different ramp generators 56 to achieve the same results. Provided that one skilled in the art knows the flow rate of the pump and the voltage to angle galvanometer constant (that is, the change in the angle of the galvanometer corresponding to a particular voltage increase), the digital potentiometer of the ramp generator can be set so that the ramp generator will match the mirror sweep rate to the predicted particle speeds.

If a sufficiently fluorescent or light scattering particle passes through the flow chamber 12, a signal from the scatter detector 16, fluorescence detector 18, or PMT 54 is sent to the signal processor 20. The signal processor 20 then generates a trigger signal which is transmitted to the imaging camera 22 through the computing device 24, and a pulse is also sent to the ramp generator 56. An example of a suitable computing device 24 is a desktop or laptop Pentium class processor based personal computer. The primary functions of the computing device 24 are to control the signal processor 20 and ramp generator 56 and to read in and analyze the images from the image capturing system 22 and the measurements from the signal processor 20 and to collate the measurements and images.

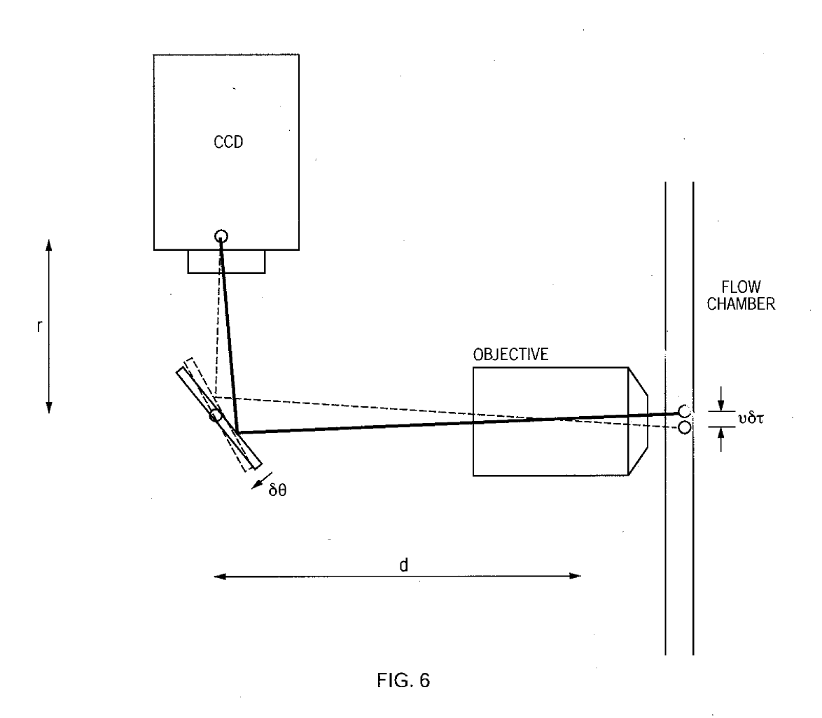

Once the ramp pulse is sent to the ramp generator 56, the ramp generator 56 generates a voltage ramp which is used to steer the scanning galvanometer and mirror combination 28 to track the passing particle. An example of a suitable galvanometer and mirror combination 28 is model 6210H galvanometer with a 6 mm diameter mirror available from Cambridge Technology, Inc., (Cambridge, Mass., USA). An example of suitable galvanometer driver electronics is a model 677 circuit board from Cambridge Technology, Inc. Prior to the beginning of a run of images and fluorescence and scatter measurements, the ramp generator 56 is programmed to sweep the galvanometer and mirror combination 28 at a rate which allows for the camera 22 to track the passing particles. As shown in FIG. 6, a particle which is passing at velocity v generates an image from the microscope objective 32 which moves across the mirror at a speed of Mv, where M is the system magnification. To compensate for this, the galvanometer and mirror combination 28 which is a distance r from the camera must turn at an angular rate of δθ/δτ=Mv/r in order to reflect the image of the particle to the same spot on the camera for as long as possible. Given the flow rate and flow chamber/cell 12 dimensions, the galvanometer and mirror combination 28 must move at an angular velocity of θ/δτ=Flow/(D×W) where D and W are the depth and width of the flow chamber 12.

In other embodiments, the tracking mirror scan rate may be adjusted manually or automatically without requiring knowledge of the dimensions of the flow chamber 12. Manual adjustment of the galvanometer/mirror combination 28 embodiment is possible if the instrument is placed in an image acquisition mode with the value of the digital potentiometer adjustable via a computer “dialog box” or “computer controlled slider” and if the user is able to adjust the image clarity while looking at the acquired images. In an automatic adjustment mode, it is possible that the image acquisition software can adjust the image clarity by changing the value of the resistance R of the digital potentiometer. Since the image clarity is measured by the image “edge gradient,” in an automated adjustment scenario, the edge gradient may be maximized by the software while the software is adjusting the value of R.

The backlighting generator 14 is configured to flash while the galvanometer/mirror combination 28 is sweeping, as shown in FIGS. 3 and 4. In the fluorescence and scatter mode of operation, when a fluorescent or light scattering particle passes through the area illuminated by the light source, the particle generates a signal which the signal processor 20 monitors. The signal processor 20 carries out an analysis interval to determine if the signal is strong enough to track, i.e., above the predetermined threshold. For example, particles of interest should emit signals significantly stronger than simply noise or small particles of debris in the sample. If the signal is strong enough as determined during the analysis interval, the signal processor 20 initiates a particle tracking interval with a mirror pulse. The mirror pulse is converted to a mirror ramp signal by the programmable ramp generator 56. The mirror pulse/ramp is followed by a camera trigger pulse and then a flash signal to the backlighting generator 14. The computing device 24 then reads in the resulting image and data regarding the scatter and/or fluorescence data. The computing device 24 is programmed to store the information received from the signal processor 20 and to make calculations associated with the particles detected. For example, but not limited thereto, the computing device 24 may be programmed to provide specific information regarding the fluorescence of the detected particles; the shape of the particles, dimensions of the particles, and specific features of the particles. The computing device 24 may be any sort of computing system suitable for receiving information, running software on its one or more processors, and producing output of information, including, but not limited to, images and data that may be observed on a user interface.

The signal processor 20 is also connected to the backlighting generator 14. The signal processor 20 may include an arrangement whereby a user of the system 10 may alternatively select a setting to automatically generate a particle tracking interval at a selectable time point or at particular time intervals. The particle tracking interval generated produces a signal to activate the operation of the galvanometer ramp generator 56 and the backlighting generator 14 so that a light flash is generated. Specifically, the backlighting generator 14 may be a light emitting diode (LED) or other suitable light generating means that produces a light of sufficient intensity to backlight the flow chamber 12 and image the passing particles. In one embodiment the backlighting generator 14 may be a very high intensity LED flash such as a 670 nm LED flash, or a flash of another suitable wavelength, which is flashed on one side of the flow chamber 12 for 200 μsec (or less). At the same time, the image capturing system 22 positioned on the opposing side of the flow chamber 12 is activated to capture an instantaneous image of the particles in the fluid as “frozen” when the high intensity flash occurs and the galvanometer/mirror combination 28 tracks the particle. The image capturing system 22 is arranged to either retain the captured image, transfer it to the computing device 24, or a combination of the two. The image capturing system 22 includes characteristics of a digital camera or an analog camera with a framegrabber or other means for retaining images. For example, but in no way limiting what this particular component of the system may be, the image capturing system 22 may be a CCD firewire, a CCD USB-based camera, a CMOS camera, or other suitable device that can be used to capture images and that further preferably includes intrinsic computing means or that may be coupled to computing device 24 for the purpose of retaining images and to manipulate those images as desired. The computing device 24 may be programmed to measure the size and shape of the particle captured by the image capturing system 22 and/or to store the data for later analysis.

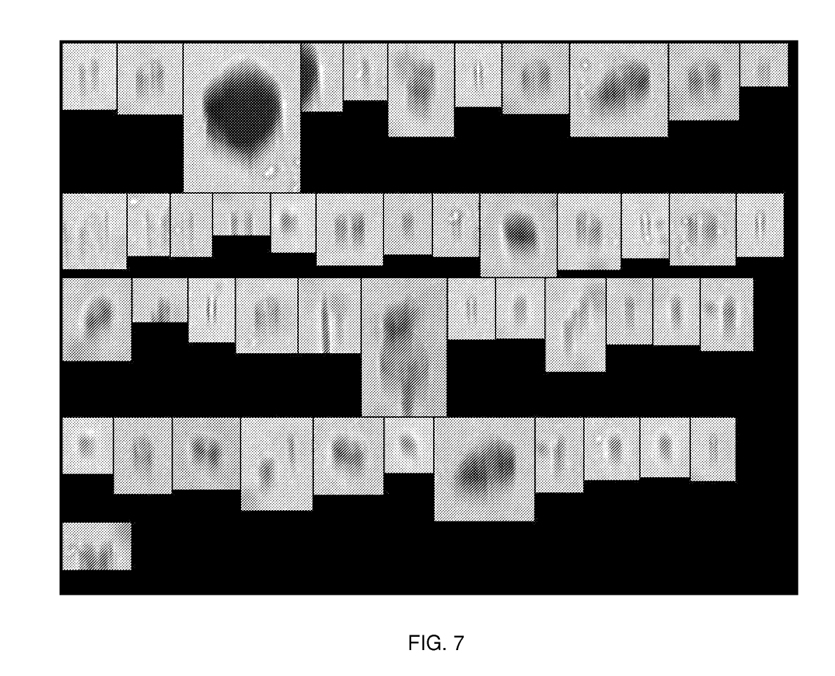

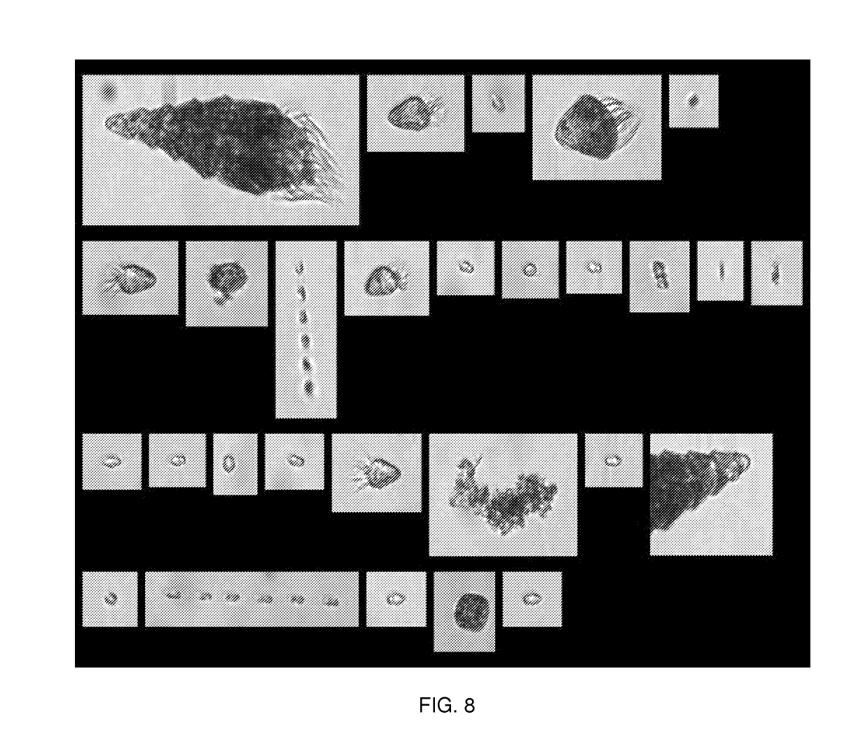

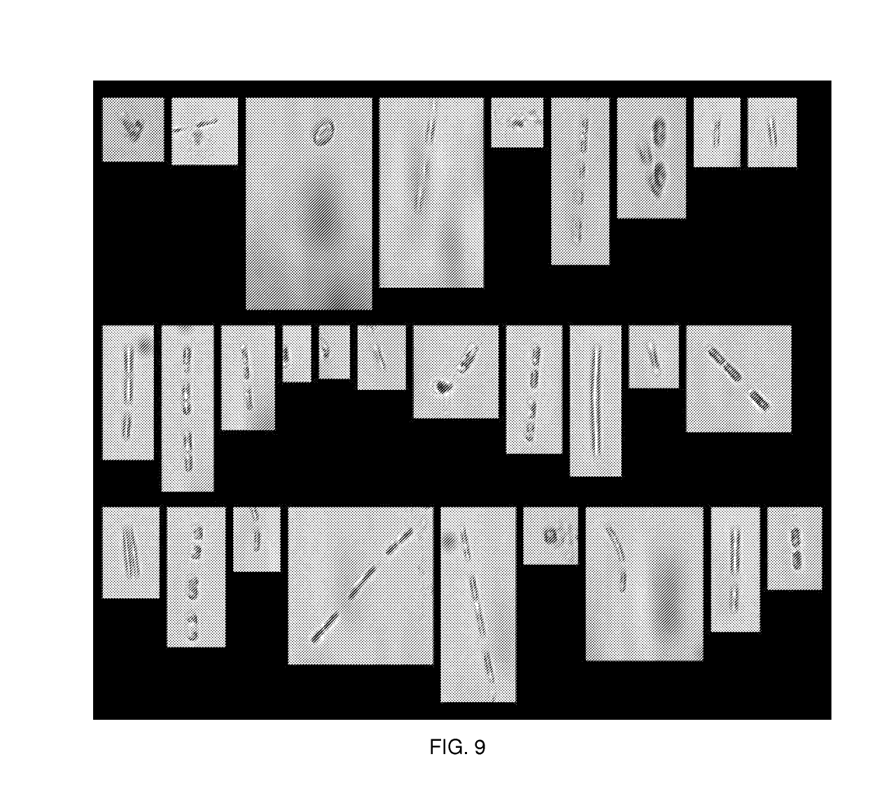

The advantages associated with the sweeping mirror enhanced imaging flow cytometer system 10 of the present invention may be readily observed by viewing the images represented in FIGS. 7-9. FIG. 7 shows a plurality of images of individual marine phytoplankton contained in a fluid as captured using an imaging flow cytometry system without a tracking mirror with a sample flow rate of 2.5 ml per minute, which is 10 times the normal sample processing rate for a system of this configuration. A 100×2000 micrometer flow chamber cross section, a magnification of 10× and an imaging flash duration of 100 microseconds were used. FIG. 8 shows a plurality of images of individual marine phytoplankton cells from the same fluid but as captured using the system 10 of the present invention with a sample flow rate of 2.5 ml per minute, a 100×2000 micrometer flow chamber cross section, a magnification of 10× and an imaging flash duration of 100 microseconds. FIG. 9 shows a plurality of images from the same sample but as captured using the system 10 of the present invention with a sample flow rate of 4 ml per minute, a 100×2000 micrometer flow chamber cross section, a magnification of 10× and an imaging flash duration of 100 microseconds. It can be easily observed that the system 10 of the present invention generates substantially sharper, less blurry images than available with the prior system even when operating at much higher sample flow rates than would otherwise be possible.

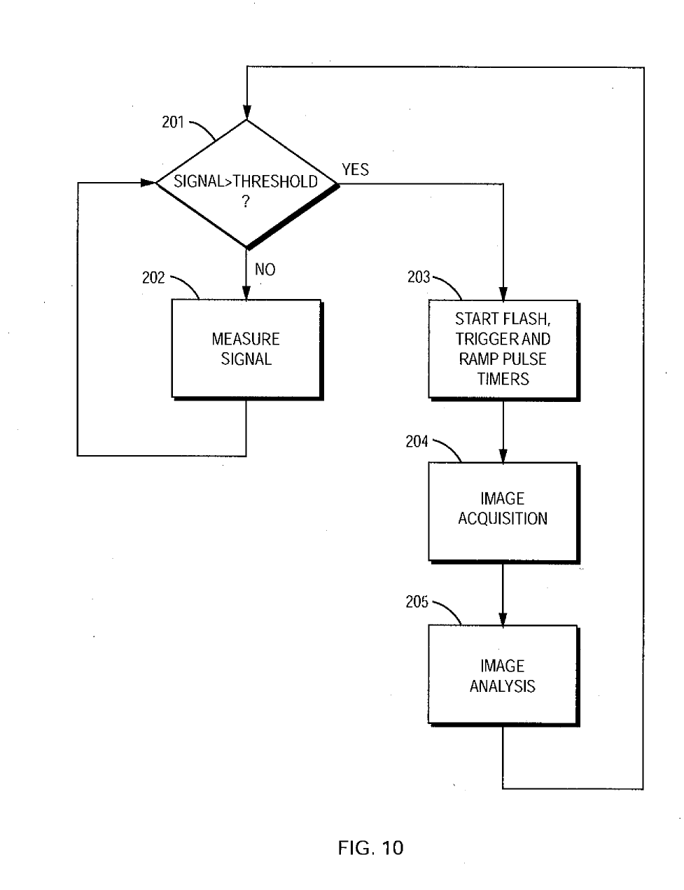

As represented in FIG. 10, a method 200 of the present invention includes steps associated with capturing images with the system 10 of the present invention. Several processes occur on a continuous basis during normal operation. For example, in one embodiment, the pump 30 draws the sample through the flow chamber 12 at a constant rate. The flow chamber 12 is illuminated with excitation light from the laser 48 continuously. The scatter and fluorescence detectors 16, 18 provide fluorescence and scatter analog waveforms to the inputs of the signal processor 20. Finally, the signal processor 20 continuously reads these signals.

In addition to these continuous processes, discrete steps are carried out. During step 201, fluorescence signals from the PMTs 54, and/or scatter detector 16, are compared to a preset threshold. If the signals are not greater than the threshold, the waveforms are measured again in step 202. If they are greater than the threshold, the digital signal processor 20 executes step 203, where the signal processor 20 generates a particle tracking interval by initiating the timers that control the mirror pulse and ramp, camera trigger, and flash signals. Executing step 203 causes the programmable ramp generator 56 to generate a mirror pulse and ramp, generating a voltage ramp which is used to steer the scanning galvanometer and mirror combination 28. This causes the galvanometer/mirror combination 28 to track the passing particle. Executing step 203 also activates the image capturing system and flash so that the system 10 can capture an image of the passing particle while the high intensity flash occurs. The tracking, triggering and the imaging flash all occur within the period that the mirror pulse and ramp are occurring, as shown in FIGS. 3 and 4. During step 204 of the method of the present invention the image capturing system 22 transfers the captured image to the computing device 24. During the image analysis step 205, the computing device analyzes the image for particles and if any particles with acceptable characteristics are found, the device stores their images and their fluorescence, scatter and other measurements.

The present invention has been described with respect to various examples. Nevertheless, it is to be understood that various modifications may be made without departing from the spirit and scope of the invention. All equivalents are deemed to fall within the scope of this description of the invention.

What is claimed is:

1. A system for imaging particles in a fluid, the system comprising:
a. a flow chamber, the flow chamber including a channel arranged to transport a fluid therethrough at a selectable rate;
b. a device configured to create a controllable fluid flow rate in the flow chamber;
c. a backlighting generator arranged to illuminate the fluid in the flow chamber;
d. an objective arranged to receive incident optical radiation from the flow chamber;
e. a light source arranged to generate light scatter and/or fluorescence from particles;
f. one or more detectors to detect light scatter and/or fluorescence emitted from the particles upon illumination;
g. a signal processor configured to receive signals from the one or more detectors;
h. a tracking mirror arranged to receive the incident optical radiation from the objective, wherein the tracking mirror is configured to track particles in the fluid traveling in the flow chamber; and
i. an image capturing system including means to capture images of particles in the fluid directed from the tracking mirror.

2. The system of claim 1, wherein the tracking mirror is a scanning mirror and galvanometer, wherein the scanning mirror and galvanometer are arranged to be controlled by signals transmitted from the signal processor through a programmable ramp generator.

3. The system of claim 1, wherein the tracking mirror is configured to track particles in the fluid traveling in the flow chamber by changing the angular rate of motion of the mirror based on a known fluid flow rate and known dimensions of the flow chamber.

4. The system of claim 1, wherein the tracking mirror is configured to track particles in the fluid traveling in the flow chamber by changing the angular rate of motion of the mirror by manual or automatic adjustment based on image clarity.

5. The system of claim 1, wherein the backlighting generator is a light emitting diode flash.

6. The system of claim 1, wherein the backlighting generator is generates a high intensity flash.

7. The system of claim 1, wherein the system further includes a computing device to receive signals from the image capturing system.

8. The system of claim 1, wherein the image capturing system includes a computing device.

9. The system of claim 1, wherein the image capturing system includes a digital camera or an analog camera and a framegrabber.

10. The system of claim 1, wherein the image capturing system includes a CCD or a CMOS camera.

11. The system of claim 1, wherein the light source is a laser.

12. A system for imaging particles in a fluid, the system comprising:
a. a flow cytometer including a flow chamber for transporting the fluid therethrough, a fluid transport device configured to create a controllable constant fluid flow rate in the flow chamber, a microscope objective arranged to receive incident optical radiation from the flow chamber and an image capturing system to capture images of the particles in the fluid; and
b. a tracking mirror arranged between the microscope objective and the image capturing system, wherein the tracking mirror is configured to track the particles in the fluid traveling through the flow chamber.

13. The system of claim 12, further comprising a galvanometer coupled to the tracking mirror.

14. The system of claim 12, wherein the galvanometer and tracking mirror are arranged to move in proportion to the fluid flow rate caused by the fluid transport device.

15. A method for imaging particles in a fluid which is transported through a channel of a flow chamber at a selectable rate and illuminated with a light source so that scatter and/or fluorescence signals are detected, the method comprising the steps of:
a. comparing the scatter and/or fluorescent signals to a preset threshold, and if the signals are less than the threshold, continuing to detect and compare signals, and if the signals are greater than the threshold, proceeding to the next step;
b. generating a particle tracking interval to track particles in the fluid traveling in the flow chamber; and
c. imaging the tracked particle and transferring the captured images to a computing device.

16. The method of claim 15, wherein the method further includes the step of analyzing the image for particles.

17. The method of claim 15, wherein the step of generating a particle tracking interval controls a tracking mirror, activates a backlighting generator, and activates an image capturing system.

18. The method of claim 17, wherein the tracking mirror is coupled with a galvanometer, and the mirror/galvanometer combination is controlled by a programmable ramp generator configured to move the mirror/galvanometer combination in proportion to the fluid being transported through the flow chamber at the selectable rate.

19. The method of claim 17, wherein the backlighting generator is a light emitting diode flash.

20. A method for imaging particles in a fluid, the method comprising the steps of:
a. transporting the fluid through a channel of a flow chamber at a selectable rate;
b. illuminating the fluid with a light source arranged to generate light scatter and/or fluorescence from the particles;
c. transmitting a signal from a scatter detector and/or a fluorescence detector to a signal processor and, if the signal meets a predetermined threshold, initiating a particle tracking interval including controlling a tracking mirror, activating a backlighting generator, and activating an image capturing system; and
d. imaging the tracked particle and transferring the captured images to a computing device.

21. The method of claim 20, wherein the method further includes the step of analyzing the image for particles.

22. The method of claim 20, wherein the tracking mirror is coupled with a galvanometer, and the mirror/galvanometer combination is controlled by a programmable ramp generator configured to move the mirror/galvanometer combination in proportion to the fluid being transported through the flow chamber at the selectable rate.

23. The method of claim 20, wherein the backlighting generator is a light emitting diode flash.
